(19) United States
(12) Patent Application Publication
(10) Pub. No.: US 2016/0027102 A1
(43) Pub. Date: Jan. 28, 2016

(54) METHOD AND SYSTEM FOR PROVIDING ELECTRONIC FINANCIAL ASSISTANCE

(71) Applicant: United Services Automobile Association, San Antonio, TX (US)

(72) Inventors: Eric Smith, Helotes, TX (US); Neff Hudson, San Antonio, TX (US); Michael P. Bueche, JR., San Antonio, TX (US); Josh Williams, San Antonio, TX (US); Gary Lotts, San Antonio, TX (US); Olvin B. Lewis, New Braunfels, TX (US); Justin Leggett, Bulverde, TX (US)

(73) Assignee: UNITED SERVICES AUTOMOBILE ASSOCIATION, San Antonio, TX (US)

(21) Appl. No.: 14/339,865

(22) Filed: Jul. 24, 2014

(51) Int. Cl. G06Q 40/00

(52) U.S. Cl. CPC G06Q 40/00

(57) ABSTRACT

A method for providing real-time monitoring of and advice relative to user's personal finances is provided. One or more financial goals are received from a user. Financial data associated with the user and stored in one or more financial information data sources is accessed. The accessed financial data is analyzed based upon the one or more financial goals. One or more financial recommendations are provided based on the analyzed financial data and responsive to an occurrence of a user event related to an expenditure of user's funds.

### FIELD OF THE INVENTION

The present disclosure relates generally to managing and tracking personal finances, and more particularly, to an electronic system and method configured and operational to provide real-time monitoring, alerting and advice relative to user's financial spending.

### BACKGROUND OF THE INVENTION

A variety of technologies exist for consumers wishing to utilize a central repository to help manage their financial information. For example, Microsoft Money and Intuit Quicken each allow users to enter information regarding their financial accounts and track transactions in those financial accounts. Other entities may also provide similar proprietary and/or open source personal finance software. Some personal finance software allows some transactions to be automatically updated via an electronic communication between the personal finance software and a data provider of the financial institution. Thus, when the necessary information for the user's financial accounts is entered into the personal finance software, the personal finance software may download recent transactions for the user's financial accounts. However, these updates typically happen only periodically. For example, recent transactions may be downloaded each time the user accesses the personal finance software and/or requests updated transaction information. Other financial accounts may not have electronic communication capabilities established and, therefore, may require the user to manually enter transaction data into the personal finance software.

With account information for multiple financial accounts entered into the personal finance software, the personal finance software can be very useful in tracking transactions, balances, and trends across multiple financial accounts associated with the consumer. However, users are opening an increasing quantity of per capita financial accounts, such as credit card, checking, saving, loan, investment, and specialty store credit accounts, to the point that a single user, or user's family unit, may easily have ten, twenty or more financial accounts that they wish to track in personal finance software. In order to begin tracking these multiple financial accounts, though, users must first remember all of the accounts that they have opened, and, second, must manually provide all of their account information into the personal finance software, such as by locating statements associated with the various accounts and copying account information into the personal finance software. This process of setting up accounts in the user's personal finance software can be tedious and may motivate the user not to bother tracking their less frequently used financial accounts in the personal finance software. Additionally, the user may forget to provide account information for new accounts that have been established after they have already set-up their pre-existing accounts with their personal finance software.

### SUMMARY OF THE INVENTION

The purpose and advantages of the illustrated embodiments will be set forth in and apparent from the description that follows. Additional advantages of the illustrated embodiments will be realized and attained by the devices, systems and methods particularly pointed out in the written description and claims hereof, as well as from the appended drawings.

In accordance with a purpose of the illustrated embodiments, in one aspect, a computer-implemented method for providing real-time monitoring of and advice relative to user's personal finances is provided. One or more financial goals are received from a user. Financial data associated with the user stored in one or more financial information data sources is accessed. The accessed financial data is analyzed, using a processor, based upon the one or more financial goals. One or more financial recommendations are provided based on the analyzed financial data and responsive to an occurrence of a user event related to an expenditure of user's funds.

In another aspect, a computer program product for providing real-time monitoring of and advice relative to a user's personal finances comprises one or more processors, one or more computer-readable storage devices, and a plurality of program instructions stored on at least one of the one or more storage devices for execution by at least one of the one or more processors. The plurality of program instructions includes program instructions to receive one or more financial goals from a user. The plurality of program instructions further includes program instructions to access financial data associated with the user stored in one or more financial information data sources. The plurality of program instructions further includes program instructions to analyze the accessed financial data based upon the one or more financial goals. The plurality of program instructions further includes program instructions to provide one or more financial recommendations based on the analyzed financial data and responsive to an occurrence of a user event related to an expenditure of said user's funds.

### BRIEF DESCRIPTION OF THE DRAWINGS

The accompanying appendices and/or drawings illustrate various non-limiting, examples, inventive aspects in accordance with the present disclosure:

FIG. 1 illustrates an example communication network in accordance with an illustrated embodiment;

FIG. 2 is a block diagram of an exemplary system that may be used to provide real-time monitoring and advice relative to user's personal finances in accordance with an exemplary embodiment of the present invention;

FIG. 3 is a flowchart of operational steps of the data analyzer module of FIG. 2 in accordance with an exemplary embodiment of the present invention;

FIG. 4 is a flowchart of operational steps of the finance manager module of FIG. 2 in accordance with an exemplary embodiment of the present invention; and

FIG. 5 illustrates a typical computing system that may be employed to implement some or all processing functionality in accordance with an exemplary embodiment of the present invention

### DETAILED DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

In exemplary embodiments, a computer system component may constitute a “module” that is configured and operates to perform certain operations as described herein below. Accordingly, the term “module” should be understood to encompass a tangible entity, be that an entity that is physically constructed, permanently configured (e.g., hardwired) or temporarily configured (e.g. programmed) to operate in a certain manner and to perform certain operations described herein.

As indicated above, embodiments of the present invention include a method, system, and computer program product that can be used to electronically monitor user's personal finances and to provide a financial advice in response to detecting an occurrence of a user event related to an expenditure of said user's funds. In some embodiments, personal financial assistance system described herein is able to retrieve data from a variety of financial information data sources. This system may interact with a user via a number of interfaces. Furthermore, such software is able to retrieve user's financial goals and is configured to analyze user's financial information based on the provided financial goals to assist the user to make prudent financial decisions.

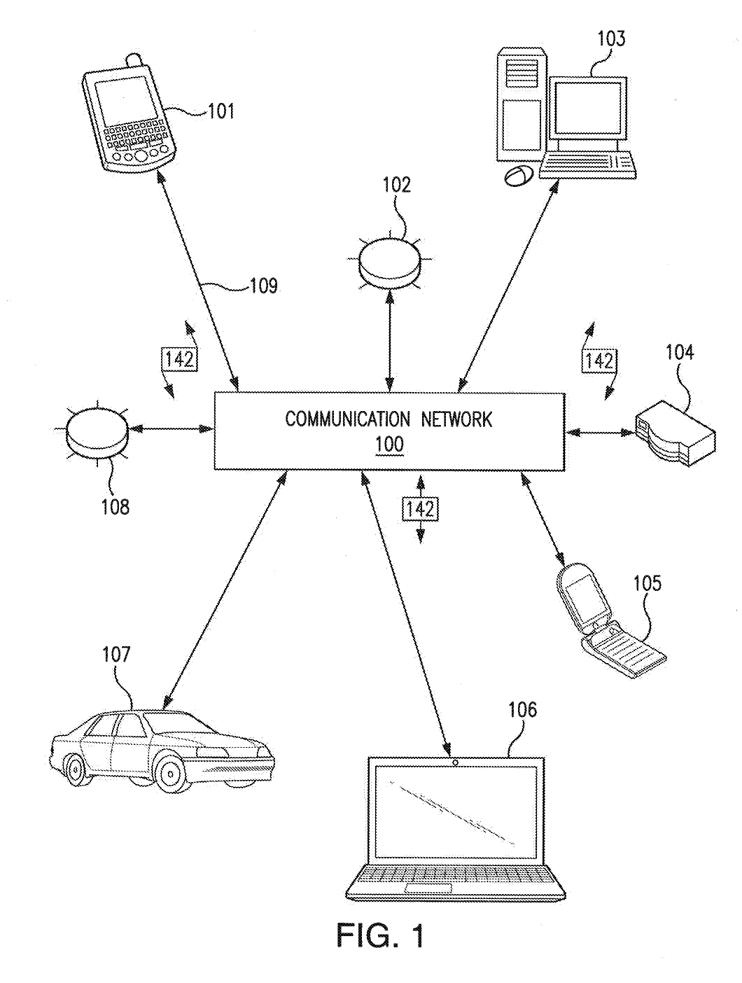

Turning now descriptively to the drawings, in which similar reference characters denote similar elements throughout the several views, FIG. 1 depicts an exemplary communications network 100 in which below illustrated embodiments may be implemented.

It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

An exemplary communication network 100 depicted in FIG. 1 illustratively comprises nodes/devices 101-108 (e.g., sensors 102, computing devices 103, mobile phone devices 105, smart phone devices 101, routers 104, laptop/tablet computers 106, automobiles 107, switches 108 and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

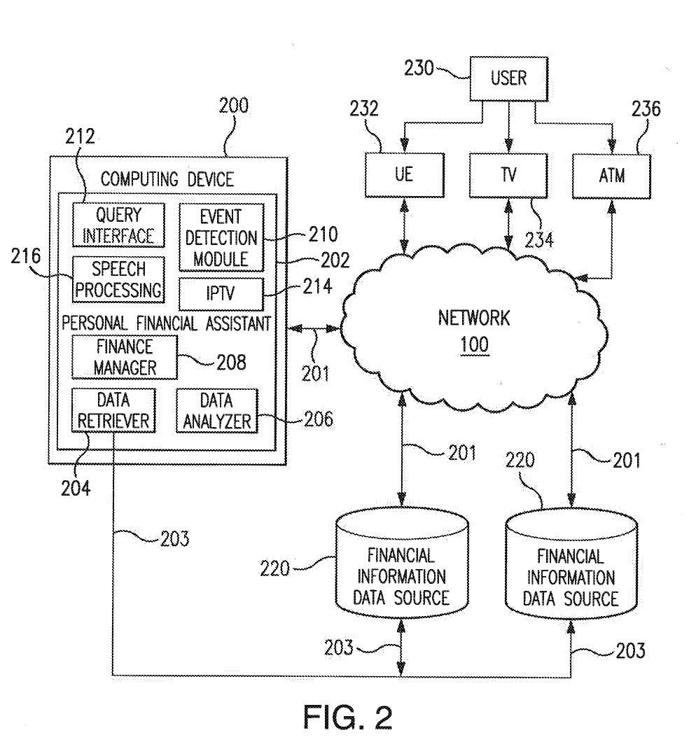

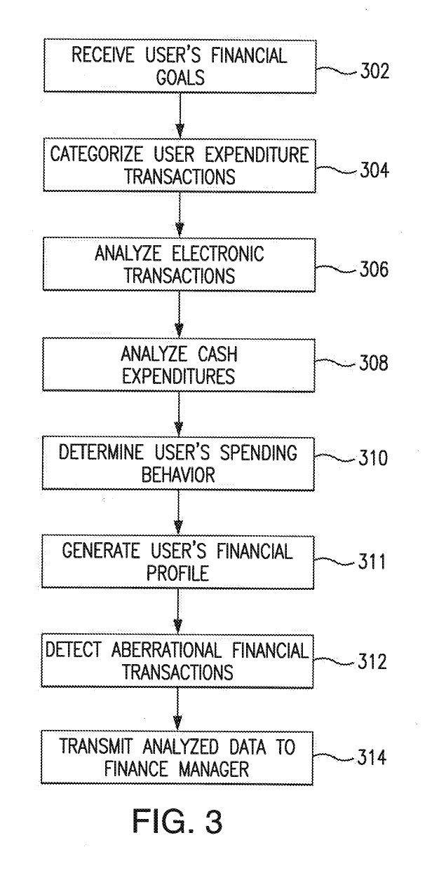

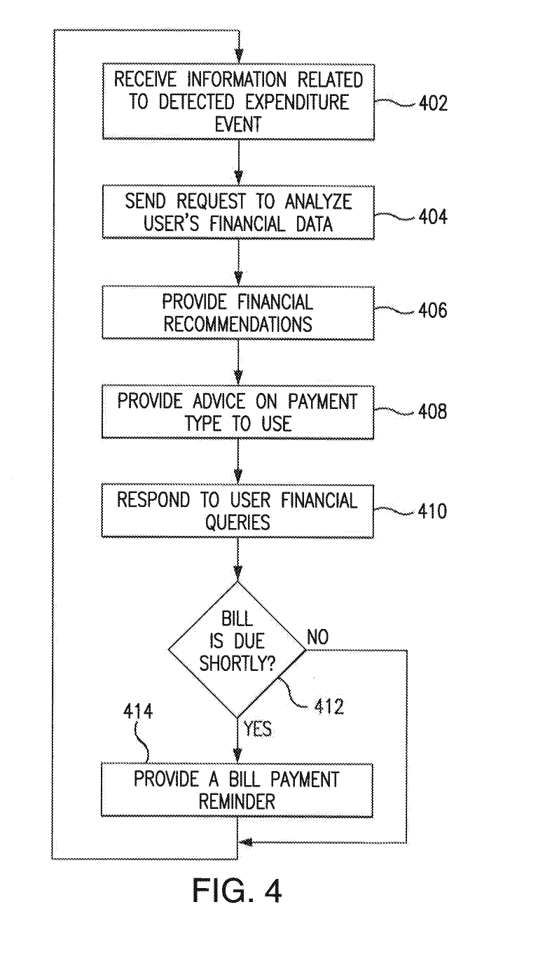

FIG. 2 is a block diagram of an exemplary system that may be used to provide real-time monitoring and advice relative to user's personal finances in accordance with an exemplary embodiment of the present invention. A personal financial assistant (PFA) system 202, which may be associated with or otherwise operatively coupled to one or more institutions such as financial services institution, may include a finance manager module 208 that may be used for providing one or more financial recommendation/advice to a user 230. The user 230 may communicate with the PFA system 202 using multi-channel connectivity across various electronic platforms. For instance, user 230 may interact with the PFA 202 by utilizing user equipment 232 (i.e., smart phones, desktop/portable computers, tablet devices, game platforms), TVs 234 (e.g., Internet Protocol Television (IPTV)), ATM machines 236, and the like. The data retriever module 204 may retrieve user's latest financial information from storage, such as one or more financial information data sources 220, and may pass the retrieved information to data analyzer 206, which may process a request sent by finance manager 208 to analyze the retrieved financial information based on provided financial goals, as described below in conjunction with FIG. 3. The data analyzer 206 may transmit analyzed data to finance manager 208. As described below in detail with reference to FIG. 4, finance manager 208 may be configured to provide financial advice and/or recommendations for the user 230 related to either actual or contemplated financial transactions. The finance manager 208 may also store information pertaining to the user's purchase and/or provided recommendation in storage, such as in financial data sources 220.

It is to be understood that user 230 may have various interactions with marketplace merchants and financial institutions which may involve spending user's funds. A conventional credit card payment at a point of sale (POS) is performed at a merchant/retailer existing POS connected to a credit card processing payment service provider (PSP) platform to process credit card payments. The backend/backbone PSP platform is connected to the POS terminal. Payment PSP's networks such as Visa®, MasterCard®, and others utilize a payment processing system run through the backend platform to settle payments made by a user provided with a card issued by a financial institutions, which is swiped or put in to a slot if it is a smart card, and read by the

POS terminal when the end user makes a purchase at a retailer. According to an embodiment of the present invention, an event detection module 210 may be operatively interconnected with the credit card PSP platform and may be configured to detect an occurrence of a user event related to an expenditure of said user's funds, upon receiving user's consent.

Additionally, the commercial transactions can be conducted electronically, for example, via an e-commerce web site. Accordingly, in an embodiment of the present invention, the event detection module 210 can be integrated with eWallets such as PayPal™ and Google™ checkout, and the like. The event detection module 210 may receive a notification from the payment processing system and/or eWallet that there is a pending user event (i.e. purchase/financial transaction) for the user being monitored by the event detection module 210. In response to receiving such notification, according to an embodiment of the present invention, the event detection module 210 may trigger financial analysis conducted by data analyzer 206. This analysis enables finance manager 208 to provide the user 230 with one or more financial recommendations related to the pending purchase, as described below. According to another embodiment of the present invention, the user 230 may generate a user event by submitting a query to solicit specific information from the PFA 202.

PFA 202 may access or receive information from various financial information data sources 220 using one or more computer networks. One or more financial data sources 220 may contain information pertaining to users who have accounts or products hosted by one or more financial institutions, for example. Financial data sources 220 may contain financial information directed to users including, but not limited to, checking account information, savings account information, mortgage loan information, student loan information, automobile loan information, personal loan information, credit card information, money market account information, payroll information and home equity line of credit information. Additionally, financial information data sources 220 may include information associated with one or more financial goals of the user 230. Each data source 220 may provide different specialized financial data for use by data analyzer 206, finance manager 208, and other software components. These financial information data sources 220 may reside on computer servers located within the same entity housing PFA 202, or they may reside on remote networks, interconnected, for example, via the Internet 100. Alternatively, data retriever component 204 of the PFA 202 may be interconnected with one or more financial information data sources 220 through dedicated and secure connections 203, as illustrated in FIG. 2.

In an embodiment of the present invention, PFA 202 may obtain information pertaining to user's financial goals, for example, by providing a questionnaire that requests relevant information. The questionnaire may be pre-filled or personalized with data already stored in financial information data source 220. The PFA 202 may generate a financial recommendation related, for example, to a pending or recently made purchase based, at least in part, on the information obtained from the user 230 via a questionnaire.

Other components of PFA 202 include one or more user interfaces (not shown in FIG. 2) which allow the user 230 to interact with PFA 202 virtually at any time (24/7) and in real time. These may include a home interface (e.g., a home wired for digital control), an auto interface (e.g., a navigation system), interactive television, game platform interface, computer, cell phone and/or personal digital assistant, ATM, and even a watch or other wearable computing devices. Each interface may be directly associated with the equipment within which PFA 202 is housed, or may be remotely located and in communication with PFA 202 using computer network 100 or other electronic communication scheme. Via such user interfaces, the PFA 202 can communicate with many different types of heterogeneous user devices, and the PFA 202 is not limited to communication with a homogeneous set of devices. Other interfaces may also or alternatively be used.

Query and response abilities enabled, for example, by query interface 212 may further enhance PFA 202. Using a keyboard or speech processing the user 230 may query PFA 202 with regard to various aspects of financial advice. For example, the user 230 may request that PFA 202 provide an advice related to a particular purchase by typing or saying ,” Can I afford this?” This type of query generates a user event, which triggers a corresponding financial analysis. Based on the result of said analysis, PFA 202 may provide a response (e.g., whether the user 230 can afford the purchase and/or provide an advice related to a payment type to use, i.e. a particular credit card, debit card, etc.) as an audible or visual message. Similar queries may search user's financial data related to user's college funds, credit scores, financial goals, spending behavior, and so forth, to provide real-time guidance and recommendations. Additional functionality may be implemented as a part of PFA 202, including for example, the ability to initiate a text message, email, and so on to provide financial advice in real time.

User 230 may interact with PFA 202 through one of many interfaces, as previously described. Interfaces may require some combination of visual, touch, or audible communication between user 230 and PFA 202. For example, user 230 may control PFA 202 using an audio interface using a conventional telephone, a cell phone, or even a microphone and speaker attached to a computer. User 230 may use push button tones or another electronic interface to make selections from a menu. User 230 may also use natural language and/or spoken commands via the audio interface (not shown in FIG. 2). Speech processing interface 216 may then process spoken commands/queries and translate them into text or another format which PFA 202 can understand. Software components or systems which perform such speech processing may be referred to as interactive voice response (IVR) systems.

According to an embodiment of the present invention, queries/commands may be sent to PFA 202 and responses received by the user 230 using the same interface. For example, using a standard UE 232 such as a cell phone, user 230 may send messages using Short Message Service

(SMS), multimedia message service (MMS), WhatsApp message service (an alternative to SMS), email, Twitter, Facebook or some other message standard known in the art. Using the example of PFA 202 implemented using Java, SMS messages may be received and sent using a Java SMS Software Development Kit (SDK), or another set of software classes which ease the development process of SMS communications. Other programming languages may have similar SDK's to enable easy programming with SMS.

In an embodiment of the present invention, computing device 200 may be a web server which may supply an interface from PFA 202 to any computer, tablet, cell phone, smart phone, or other electronic device having a web browser via computer network 100, such as the Internet. Such an interface may provide pages formatted using Hypertext Markup Language (HTML) or some other markup language to provide information to user 230 and to receive information from the user 230. The HTML pages may be created using a standard programming language such as Java Servlets or Java Server Pages (JSPs), Microsoft .NET, PHP, and so forth.

Another alternative interface for PFA 202 is an Internet Protocol Television (IPTV) interface 214. IPTV is not a particular standard and rather is a term used to refer generally to interactive services delivered to users over television broadband networks. IPTV 214 may require that the user 230 have a separate set top box connected to a television 234, although the functionality may be included as part of a television, or other video component. User 230 may receive information/advise from PFA 202 through his/her television 234. Likewise, user 230 may access and control PFA 202 using a television remote or other input device.

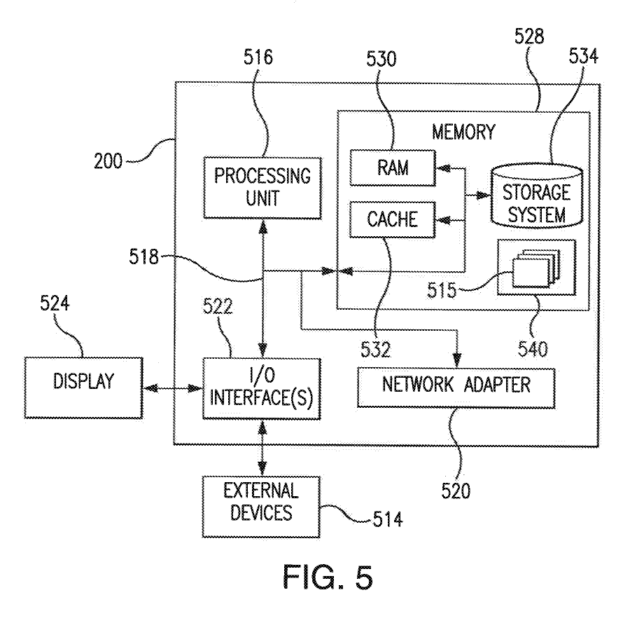

In an embodiment of the present invention, the PFA 202 may comprise one or more additional software modules (not shown in FIG. 2). These software modules may be used in the performance of the techniques and operations described herein and may be operatively coupled to the data retriever 204, data analyzer 206 and finance manager 208 modules. Example software modules may include, without limitations, modules for sending and receiving information between the PFA 202 and the user 230, requesting and retrieving information from one or more financial information data sources 220, and generating web pages described herein. While specific functionality is described herein as occurring with respect to specific modules, the functionality may likewise be performed by more, fewer, or other modules. The functionality may be distributed among more than one module. An example computing device and its components are described in more detail with respect to FIG.5.

FIGS. 3 and 4 are flowcharts of operational steps of the data analyzer module 206 and finance manager module 208 of FIG. 2 in accordance with exemplary embodiments of the present invention. Before turning to description of FIGS. 3 and 4, it is noted that the flow diagrams shown therein are described, by way of example, with reference to components shown in FIGS. 1-2, although these operational steps may be carried out in any system and are not limited to the scenario shown in the aforementioned figures. Additionally, the flow diagrams in FIGS. 3 and 4 show examples in which operational steps are carried out in a particular order, as indicated by the lines connecting the blocks, but the various steps shown in these diagrams can be performed in any order, or in any combination or sub-combination. It should be appreciated that in some embodiments some of the steps described below may be combined into a single step. In some embodiments, one or more additional steps may be included.

As previously indicated, in certain embodiments of the present invention the event detection module 210 may be configured and operable to detect user events associated with expenditure of user's funds. Such events may include, without limitation, either actual or contemplated expenditure and/or query or command received from the user 230. In response to detecting one of the user events, the event detection module 210 may send information related to the detected expenditure event/query to finance manager module 208. Upon receiving such information, the finance manager 208 may send a corresponding command to data analyzer 206. This command may comprise a request to perform real-time financial analysis related to the detected expenditure event/query. Referring to FIG. 3, at 302, the data analyzer 206 may receive a request to analyze financial information related to a particular expenditure event. In an embodiment of the present invention, the received data analysis request may specify user's financial goals. According to an embodiment of the present invention, in response to receiving the data analysis request, the data analyzer 206 may instruct data retriever module 204 to access and retrieve financial data pertinent to the analyzed user. It is noted that received financial goals may include either long term goals, short term goals or both. For instance, financial goals may be related to any of the following: income, investments, bill reduction, retirement planning, debt reduction, budgeting, coupons, savings, insurance, wills/trusts, vacation plans, and/or college funds. As previously indicated, PFA 202 may obtain information related to user's financial goals via a questionnaire and/or any interfaces described above in relation to FIG. 2.

In accordance with an embodiment of the present invention, the data analyzer module 206 may be configured and operable to keep track of and monitor expenditures according to a predetermined set of expenditure categories for purposes of budgeting and/or managing personal finances. For instance, for purposes of performing financial analysis, the data analyzer 206 may need to know not only how much money is currently available in the customer's checking, savings or money-market account, but also what types and amounts of expenditures have been made during the previous month or several months on such items as food, clothing, entertainment, mortgage, rent, etc. In this manner, the data analyzer 206 managing user's personal finances can identify possible problem areas in which expenses should be reduced in an effort to reduce overall costs and to save money. Accordingly, at 304, the data analyzer module 206 may process the received financial data by classifying this data according to a predetermined set of expenditure categories in reconciliation with financial budgeting goals.

At 306, the data analyzer 206 may analyze electronic transactions based upon short term and long term financial goals provided by the user. Further, electronic transaction data sent to the data analyzer 206 can be analyzed based on various types/categories of purchase including, but not limited to, credit card, debit card, check, electronic check, ATM withdrawal, Automated Clearing House (ACH) payments and other forms of electronic transactions. It should be understood that financial data received by the data analyzer 206 may include cash expenditure history in the form of receipt data. At 308, the data analyzer 206 may perform an analysis of cash expenditures. Receipt data may be generated as a result of cash purchases, and paper receipts can be scanned by the user 230 and processed by PFA 202 for inclusion in the financial information data source 220. Thus, at 308, the data analyzer 206 may perform analysis of receipt data associated with the user 230.

Next, at 310, the data analyzer 206 may determine user's spending behavior. For instance, the data analyzer 206 may utilize historical user spending data (e.g., spending data for past 24 months) of completed transactions indicative of user spending patterns. As a result of overall analysis of user's financial data, including analysis performed at 304-310, at 311, the data analyzer 206 may generate a user's financial profile. The financial profile may include, for example, a spending behavior (e.g., being a heavy shopper, preferring a certain shop or a group of shops or a method of payment, having/not having applied for certain credit cards or the like), an investment portfolio (e.g., investments in stocks, mutual funds, retirement plans, etc.), a financial standing, and the like.

According to an embodiment of the present invention, the data analyzer module 206 may utilize one or more models, for example, to detect aberrational financial transactions, at 312. The desired variables may be first defined using a modeling language (such as the Capstone Model Manager Language) to define and calculate all variables that may be used in the model. Defining the variables in separate files (based on variable categories) and then including them into the main model can further localize the variables. The model utilized by the data analyzer 206 preferably is a statistical model, e.g., a neural network or regression model, but may also include rules for further financial transaction processing. In accordance with an embodiment of the present invention, this modeling approach may use one or more profiles generated at 311 to determine whether a particular transaction (e.g., a pending transaction detected by the event detection module 210) is aberrational. As previously mentioned, the generated financial profile may include at least user's historical spending behavior. In addition, this statistical model may employ a set of rules. Such rules may be useful in controlling model inputs and outputs. For example, rules may be written to flag transactions with certain attributes (e.g. very high transaction amount). At 314, the data analyzer 206 preferably sends results of the analysis performed at 306-312 to finance manager 208. These results may include, for example, user's financial profile, identified aberrational transactions, and the like.

FIG. 4 is a flowchart of operational steps of the finance manager module of FIG. 2 in accordance with an exemplary embodiment of the present invention. According to an embodiment of the present invention, the finance manager 208 may be operatively interconnected with the event detection module 210 and the data analyzer 206 and may be configured and operable to provide one or more financial recommendations/advice to user 230. At 402, the finance manager 208 may receive information related to a detected expenditure event from the event detection module 210. As previously mentioned, a detected expenditure event may include, without limitation, either actual or contemplated expenditure, which may be received from the credit card PSP platform, for example, and/or may include a financial query or command received from the user 230. If the detected event is an actual financial transaction, said information received by the finance manager module 208 may be indicative of a transaction type (i.e. a deposit or withdrawal, for instance), transaction amount, corresponding account number, and the like.

At 404, the finance manager module 208 may send a request to the data analyzer 206 to perform real-time financial analysis related to the detected expenditure event/query. This request may include information about the contemplated or actual transaction received at 402, a user's financial goals and/or any additional information relevant to performing financial analysis.

At 406, in response to receiving financial analysis results from the data analyzer 206, the finance manager module 208 preferably provides one or more financial recommendations based on the analyzed financial data and responsive to an occurrence of a user event related to an expenditure of user's funds. In other words, according to various embodiment of the present invention, the finance manager 208 is enabled to provide real-time budgeting of user's personal finances based upon provided short term and/or long term financial goals. As an example, the finance manager 208 may provide expense management services. A system, according to embodiments, provides an improved user experience for quickly and easily capturing expense information such as the expenditure (transaction) type, amount, currency, notes, etc. Furthermore, if a particular expenditure comprises cash expenditure, the finance manager 208 may be configured to capture an expenditure receipt using the UE's camera and associating the receipt to the expenditure information may also be provided. As previously indicated, user interaction with the PFA 202 may be facilitated by specialized devices such as cellular phones, smart phones, dedicated devices, or by general purpose computing devices (fixed or portable) such as handheld computers, vehicle mount computers, laptops, etc.

It is contemplated that the finance manager 208 is configured to monitor multiple financial accounts of the user. Thus, the finance manager 208 preferably maintains a substantially accurate, comprehensive image of the user's financial status. According to an embodiment of the present invention, the finance manager 208 may incentivize or reward a user's adoption of the recommended saving tips. For example, the finance manager 208 may award the credit to the user based upon a monetary transfer within the user financial accounts that increases net user worth. In an embodiment of the present invention, such credit may comprise a gaming credit if the PFA 202 is operably interconnected with user's game platform. By developing a substantially comprehensive picture of the financial status of the user, debt transfer between financial accounts can be discerned from positive attempts to reduce user debt, increase savings, and/or augment investments, and positive attempts to reduce user debt, increase savings, and/or augment investments can be rewarded to incentivize such positive financial actions by the user. For example, the finance manager 208 can track a checking account, a savings account, and credit card accounts of the user 230. In this example, the finance manager 208 may identify a monetary transfer from one credit card to a second credit card as debt transfer and may identify a monetary transfer from a checking account to a student loan account as a positive attempt to reduce user debt. Continuing with this example, the finance manager 208 preferably awards the credit to the user 230 for the positive attempt to reduce debt but not for the debt transfer. It is noted that finance manager's 208 monitoring is not limited to checking, savings and credit card accounts but may also include monitoring (e.g., tracking) additional or alternative user financial accounts, such as a student loan account, a mortgage, an Independent Retirement Account (IRA), a car loan account, public or private stock holdings, or bonds held by the user 230, and the like. It is further contemplated that upon receiving a user's consent, the finance manager 208 may be enabled to monitor, track, control and/or limit spending of user's family members based on the provided financial goals.

It is further noted that since the finance manager 208 maintains a substantially accurate, comprehensive image of the user's financial status, the provided financial recommendations are preferably contingent upon changing financial landscape (e.g., salary and other income changes, interest rate changes, tax changes, statutory changes relating to savings/income, and the like). As another example of financial recommendations provided at 406, the finance manager 208 may provide a recommendation related to consolidation/elimination of revolving user's debt. According to embodiment of the present invention, the finance manager 208 advantageously provides automated customized credit/debt management advice custom tailored to the user's credit/debt management intentions and time frame needed to improve credibility or eliminate debt while still maintaining good credit stature over a predefined period of time.

As another example, the finance manager 208 may identify various investment opportunities based on the financial analysis (e.g., portfolio analysis) conducted by the data analyzer 206. In other words, if the data analyzer 206 analyses a user's current portfolio versus investment goals of the user, then the finance manager 208 may suggest changes to the user's current portfolio either to better align the portfolio with the user's financial goals (e.g. investment goals), or to improve performance and diversification of the user's current portfolio. According to an embodiment of the present invention, the finance manager 208 may include, for example, a retirement savings accounts calculator. The retirement savings account calculator may provide recommendations on what type of account the user should use for retirement savings. Such a calculator may provide recommendations for the order in which the user should invest (i.e., 401K first, then Roth IRA, followed by either annuities or Mutual Funds). For example, if the finance manager 208 has determined that user's employer contributes a matching amount of money based on the user's own contributions, the following path may be recommended: 1) contribute $X to user's employer's plan to receive a match; 2) then contribute $X to a Roth IRA if eligible; 3) then contribute up to the maximum to user's employer's plan; 4) then contribute to a mutual fund (or annuity if in a high marginal tax bracket and need further tax sheltering).

Furthermore, the finance manager 208 may provide financial advice responsive to pending financial transaction/expenditure. For example, the finance manager 208 may provide ramifications of an immediate purchase on long term goals. For instance, if the detected user event information indicates that a user is about to spend $1000 for a non-budgeted television, in response, the finance manager 208 may notify the user in real-time that immediate expenditure of $1000 is equivalent to $30,000 in a retirement fund. This notification may allow the user to make a decision on whether to proceed with the purchase. As an illustrative embodiment of the present invention, once a user swipes his/her card at a POS terminal, the finance manager 208 may send a notification, for example to user's mobile device, prior to the transaction approval from the corresponding financial institution (i.e., credit card company). In other words, advantageously, the finance manager 208 may allow a user to cancel the pending transaction before the purchase is complete. It is noted that to enable such an embodiment, (PSP) platform, eWallets or other credit card payment processing platforms may introduce a relatively short processing delay to allow the PFA 202 to provide a timely financial advice. As yet another non-limiting example, the finance manager 208 may provide ramifications of a long-term financed expenditure based upon user's financial goals. For instance, the finance manager 208 may calculate additional years of user's employment after planned retirement age to compensate for purchase of home, automobile or other significant expenses not originally budgeted for, based on user's current financial situation and based on user's financial goals. Other non-limiting examples of financial recommendations may include one or more spending recommendations based at least in part on user provided criteria, funds allocation recommendations based upon satisfaction of a financial obligation, credit card balance transfer recommendations based, for example, on current interest rates, and the like.

Referring back to FIG. 4, at 408, the finance manager 208 may optionally provide an advice identifying an optimal payment method to use for a particular financial transaction. For instance, the finance manager 208 may recommend using a particular credit card, debit card, etc. based on particular aspects of user's financial status (e.g., current interest rates, user pay cycle, etc.).

According to an embodiment of the present invention, the finance manager 208 may also control user's healthcare budget. As an illustrative example, the finance manager 208 may determine that a user is associated with a high-deductible health plan. Typically, high-deductible plans cost less and the user pays routine medical claims using a pre-funded spending account, often with a special debit card provided by a financial institution, which may comprise, for example, an insurance company. The account may include, for example, a health savings account (HSA), a health reimbursement account (HRA), or similar medical payment product. If the balance on this account runs out, the user may use another form of payment (e.g., cash or credit card) to pay claims. Users typically can keep any unused balance or “rollover” at the end of the year to increase future balances, or to invest for future expenses. However, because healthcare costs are generally not transparent and historic details of the health plan (e.g., amount remaining in the high-deductible or amount available in the user's HSA account) may not be readily available to the user, it may be difficult for many users to decide which services to purchase and how to structure payments for such services. Thus, in this exemplary embodiment, at 408, the finance manager 208 may provide a recommendation related to a preferred mode of payment with respect to the user's healthcare budget.

It is noted that if the information received by the finance manager 208 at 402 indicates that the detected expenditure event comprises a financial query received from the user 230, at 410, the finance manager 208 may respond to such query based on the analysis described above. For example, users may be interested to know whether they can afford to make a particular purchase or they may want to know current status of their college fund or they may need a real-time guidance on how to save $2000, for example, for their planned vacation. It is contemplated that the finance manager 208 may be capable of addressing even broader user queries, i.e. “why is my credit score lower than other similarly situated users” or “what is causing me to be out of budget plan?” Thus, at 410, the finance manager 208 may respond to one or more of such queries based on comprehensive analysis of user's current financial situation, based on user's financial profile and/or based on user's financial goals.

According to an embodiment of the present invention, the finance manager 208 may also provide an integrated bill payment notification/reminder service. In various embodiments of the invention, the reminder function can be entirely free form and may be based on user-configurable preferences. For example, the user 230 can inform the finance manager 208, in one embodiment via a questionnaire described above, to send a reminder to the user 230 at a specified time and/or date, or according to a recurring schedule. The user can also name the reminder and provide specific text for the reminder. So, for example, a user 230 could set up a reminder so that it is generated by the finance manager 208 on the 15th of every month to say “monthly insurance premium is due on the 20th.” Alternatively, the finance manager 208 may be capable of determining bill payment due dates based on the information stored in the financial information data sources 220. Accordingly, at 412, the finance manager 208 may compare current date with an upcoming bill payment due dates to determine whether to send a corresponding reminder to the user 230, which may be sent at 414 (step 412, yes branch). According to an embodiment of the present invention, once the finance manager 208 sends reminders that merchant bills are due for payment, the finance manager 208 can make sure that there are sufficient funds to pay the merchants. Additionally, depending on predetermined user preferences, the finance manager 208 may initiate an automatic bill payment using a suitable user account. In response to determining that there is no need to send a bill payment reminder (step 412, no branch) or if the finance manager 208 is not configured to provide a bill payment reminder/notification, the finance manager 208 may return to step 402 and wait for next detected expenditure event. It is to be appreciated that finance manager 208 may be configured to electronically deliver all bill payment notifications, reminders as well as financial recommendations described above with respect to steps 406-414. The electronic delivery may include integration of notification functionalities into social networking services (e.g., via Facebook, Twitter, and the like). It is to be also understood and appreciated that the finance manager 208 may be configured and operational to integrate with user's communicative computing devices described above (e.g., smart phones, computers, tablets, smart TV's, vehicle communication systems, etc.) for sending such recommendations responsive to an occurrence of a user event related to an expenditure of the user's funds and/or responsive to one or more user query. In some embodiments, at least bill payment notifications may comprise audible communication.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG.5 is a schematic block diagram of an example computing device 200 (shown in FIG. 2) that may be used (or components thereof) with one or more embodiments described herein, e.g., as one of the nodes shown in the network 100. As explained above, in different embodiments these various devices are configured to communicate with each other in any suitable way, such as, for example, via communication network 100.

Device 200 is intended to represent any type of computer system capable of carrying out the teachings of various embodiments of the present invention. Device 200 is only one example of a suitable system and is not intended to suggest any limitation as to the scope of use or functionality of embodiments of the invention described herein. Regardless, computing device 200 is capable of being implemented and/or performing any of the functionality set forth herein.

Computing device 200 is operational with numerous other general purpose or special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, and distributed data processing environments that include any of the above systems or devices, and the like.

Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices.

Device 200 is shown in FIG. 5 in the form of a general-purpose computing device. The components of device 200 may include, but are not limited to, one or more processors or processing units 516, a system memory 528, and a bus 518 that couples various system components including system memory 528 to processor 516.

Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing device 200 typically includes a variety of computer system readable media. Such media may be any available media that is accessible by device 200, and it includes both volatile and non-volatile media, removable and non-removable media.

System memory 528 can include computer system readable media in the form of volatile memory, such as random access memory (RAM) 530 and/or cache memory 532. Computing device 200 may further include other removable/non-removable, volatile/non-volatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 528 may include at least one program product having a set (e.g., at least one) of program modules that are configured to carry out the functions of embodiments of the invention.

Program/utility 540, having a set (at least one) of program modules 515, such as data retriever 204, data analyzer 206 and finance manager 208 described above, may be stored in memory 528 by way of example, and not limitation, as well as an operating system, one or more application programs, other program modules, and program data. Each of the operating system, one or more application programs, other program modules, and program data or some combination thereof, may include an implementation of a networking environment. Program modules 515 generally carry out the functions and/or methodologies of embodiments of the invention as described herein.

Device 200 may also communicate with one or more external devices 514 such as a keyboard, a pointing device, a display 524, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 522. Still yet, device 200 can communicate with one or more networks such as a local area network (LAN), a general wide area network (WAN), and/or a public network (e.g., the Internet) via network adapter 520. As depicted, network adapter 520 communicates with the other components of computing device 200 via bus 518. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIG. 5 is intended to provide a brief, general description of an illustrative and/or suitable exemplary environment in which embodiments of the above described present invention may be implemented. FIG. 5 is exemplary of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A computer-implemented method for providing real-time monitoring of and advice relative to user's personal finances, the method comprising the steps of:
receiving one or more financial goals from a user;
accessing financial data associated with the user, the financial data being stored in one or more financial information data sources;
analyzing, using a processor, the accessed financial data based upon the one or more financial goals; and
providing one or more financial recommendations based on the analyzed financial data and responsive to an occurrence of a user event related to an expenditure of said user's funds.

2. The method of claim 1, wherein the financial data includes one or more of the following: checking account information, savings account information, mortgage loan information, student loan information, automobile loan information, personal loan information, credit card information, money market account information, payroll information and home equity line of credit information.

3. The method of claim 1, wherein the one or more financial information data sources are associated with one or more financial institution.

4. The method of claim 1, wherein providing one or more financial recommendations comprises reporting financial ramifications of said expenditure on the one or more financial goals.

5. The method of claim 1, wherein analyzing the accessed financial data comprises analyzing user's electronic transactions.

6. The method of claim 5, wherein analyzing the accessed financial data comprises categorizing said electronic transactions in reconciliation with financial budgeting.

7. The method of claim 1, wherein analyzing the accessed financial data comprises analyzing user's cash expenditures.

8. The method of claim 1, further comprising providing one or more automatic payment reminders related to the accessed financial data.

9. The method of claim 7, wherein said one or more automatic payment reminders comprise audible communication.

10. The method of claim 1, further comprising identifying one or more investment opportunities based on the analyzed financial data.

11. The method of claim 1, wherein providing one or more financial recommendations comprises providing one or more spending recommendations based at least in part on user provided criteria.

12. The method of claim 1, further comprising:
determining user's spending behavior based on the analyzed financial data; and
detecting one or more aberrational financial transactions based on the determined user's spending behavior.

13. A computer program product for providing real-time monitoring of and advice relative to user's personal finances, the computer program product comprising:
one or more computer-readable storage devices and a plurality of program instructions stored on at least one of the one or more computer-readable storage devices, the plurality of program instructions comprising:
program instructions to receive one or more financial goals from a user;
program instructions to access financial data associated with the user stored in one or more financial information data sources;
program instructions to analyze the accessed financial data based upon the one or more financial goals; and
program instructions to provide one or more financial recommendations based on the analyzed financial data and responsive to an occurrence of a user event related to an expenditure of said user's funds.

14. The computer program product of claim 13, wherein the financial data includes one or more of the following: checking account information, savings account information, mortgage loan information, student loan information, automobile loan information, personal loan information, credit card information, money market account information, payroll information and home equity line of credit information.

15. The computer program product of claim 13, wherein the one or more financial information data sources are associated with one or more financial institution.

16. The computer program product of claim 13, wherein the program instructions to provide one or more financial recommendations comprise program instructions to report financial ramifications of said expenditure on the one or more financial goals.

17. The computer program product of claim 13, wherein the program instructions to analyze the accessed financial data comprise program instructions to analyze user's electronic transactions.

18. The computer system of claim 17, wherein the program instructions to analyze the accessed financial data comprise program instruction to categorize said electronic transactions in reconciliation with financial budgeting.

19. The computer program product of claim 13, wherein the program instructions to analyze the accessed financial data comprise program instructions to analyze user's cash expenditures.

20. A computer system for providing real-time monitoring of and advice relative to user's personal finances, the computer system comprising one or more processors, one or more computer-readable storage devices, and a plurality of program instructions stored on at least one of the one or more storage devices for execution by at least one of the one or more processors, the plurality of program instructions comprising:
program instructions to receive one or more financial goals from a user;
program instructions to access financial data associated with the user stored in one or more financial information data sources;
program instructions to analyze the accessed financial data based upon the one or more financial goals; and
program instructions to provide one or more financial recommendations based on the analyzed financial data and responsive to an occurrence of a user event related to an expenditure of said user's funds.
